(19) United States
(12) Patent Application Publication
(10) Pub. No.: US 2003/0126182 A1
(43) Pub. Date: Jul. 3, 2003

(54) Method and apparatus for managing physical and virtual resources within a multi-function integrated chipset

(76) Inventor: David A. Wyatt, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/040,606

(22) Filed: Dec. 28, 2001

(51) Int. Cl. G06F 9/00

(52) U.S. Cl. 709/104

(57) ABSTRACT

A technique for managing physical and virtual resources within a multifunction chipset includes a resource manager in the form of a software agent that maintains a global resource namespace built from a list of parent-child object relationships. In general, the parent objects represent resource producers while the child objects represent resource consumers. By examining the various parent-child relationships in the global resource namespace, the resource manager can determine how the various system resources are being consumed. Interfaces are provided whereby software drivers can gain access to the global resource namespace information through the resource manager.

### FIELD OF THE INVENTION

The present invention pertains to the field of computer systems. More particularly, this invention pertains to the field of managing physical and virtual resources within multi-function, integrated devices.

### BACKGROUND OF THE INVENTION

Many of today's computer systems utilize highly-integrated chipsets that include a multiplicity of functional units that are shared among a variety of software clients such as device drivers. These software clients may also place demands on other system resources such as memory bandwidth. Problems may occur in the system if too many demands are placed on a system resource. For example, for computer systems that use part of the main system memory to store graphics or video data, if the various device drivers place a demand on the main system memory that exceeds the main system memory bandwidth capabilities, then visible artifacts may occur on a display screen as a result of excessive latencies experienced by a graphics controller trying to access main system memory.

Computer system designers try to solve these problems by anticipating the needs of the various system devices and providing adequate resources. Additional bandwidth resources can be obtained by increasing clock speeds, widening interfaces, improving communication protocols, etc. Device driver designers try to understand the available resources and design the software accordingly. These approaches are not without their own set of difficulties. Computer system designers cannot anticipate all of the ways that a system may be used. Device driver designers must tailor their products with a particular system configuration in mind in order to take advantage of available resources. This forces device driver designers to revise their products for every new chipset or system configuration.

Another problem results from the fact that a device driver has no knowledge of what other device driver components or other device drivers are doing, or what system resources are being used by other device driver execution threads. If a particular system resource is already being heavily used and a device driver requires additional use of that resource, the device driver will go ahead and try to use the resource even if it means that the demands on that resource will exceed the resource's capabilities (such as with the main system memory bandwidth example mentioned above). Further, with the type of system described above, there are no provisions for reacting to changing computer system demands and restraints.

Accordingly, it would be desirable to have a means for managing, predicting, and reacting to computer system demands and restraints whereby device drivers would have access to enough computer system functionality information to ensure that device driver demands remain with the limitations of the hardware.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 is a block diagram of one embodiment of a computer system that includes a highly integrated system logic device.

FIG. 2 is a diagram of an example namespace for a system logic device including a graphics controller that uses a portion of main system memory to store graphics data.

FIG. 3 is a diagram of an example namespace for a system logic device including a graphics controller that uses local graphics memory to store graphics data.

FIG. 4 is a diagram of a global resource namespace within a resource manager where the resource manager is set up in a server/client arrangement.

FIG. 5 is a flow diagram of one embodiment of a method for managing physical and virtual resources within a multifunction integrated chipset.

FIG. 6 is a flow diagram of an additional embodiment of a method for managing physical and virtual resources within a multifunction integrated chipset.

### DETAILED DESCRIPTION

In general, the example embodiments discussed below describe a technique for managing physical and virtual resources within a multifunction chipset. The embodiments discussed below include a resource manager in the form of a software agent that maintains a global resource namespace built from a list of parent-child object relationships. In general, the parent objects represent resource producers while the child objects represent resource consumers. Examples of physical resources include functional units such as graphics controller rendering engines, digital video output units, digital display outputs, video capture ports, etc. An example of a virtual resource is memory bandwidth. By examining the various parent-child relationships and their associated physical and virtual resources in the global resource namespace, the resource manager can determine how the various system resources are being consumed and balance the net available parent resources globally, as well as across the individual child consumers. Interfaces are provided whereby software drivers and driver components can gain access to the global resource namespace information through the resource manager.

The resource manager may be implemented according to a server-client model. The client portion of the resource manager can be included as part of the system's various device drivers. The clients can make calls to the server portion of the resource manager to perform various tasks involving resource management. Some of these tasks are described below. For the example embodiments described herein, there is only one instance of the resource manager server and only one instance of the global resource namespace while there are multiple instances of the resource manager clients.

An additional general explanation of the embodiments is as follows. The embodiments break the system down into classes of producers and consumers. The production of bandwidth is determined by the initial static configuration of the chipset. As consumers (child objects) are attached to producers (parent objects), the resource manager maintains a record of consumed resources as well as remaining or available resources. Feature assignments can then be treated as allocation requests and recorded in a global table. The embodiments compute the bandwidth and demands of each feature and subsystem allocations in real-time, tracking changes in the production as it is affected by external events (such as clock throttling or clock/voltage scaling). The embodiments determine the requirements of potential resource allocations, compare it to the record of net available resources, and provide simple answers to the question of whether a feature, or combination of features, is possible within the given system constraints. The embodiments also take feedback from system and user events as well as policy and uses this information to modify the state model of the system.

Among the intended benefits of the resource manager as described herein is that the various software device drivers do not need to be specially coded with any particular system configuration in mind since the abstracted system configuration information can be determined using the resource manager. Device driver designers can maximize the reuse of code and reduce development time and support efforts because there is less of a need to specifically tailor the drivers for any particular system configuration. The maximum reuse of code can also reduce validation efforts and improve software stability.

Another intended benefit of the resource manager is the ability to maximize resource usage without placing demands on a resource that exceed that resource's capabilities. For example, in a computer system there may be several system agents requiring access to main memory. The resource manager keeps a record of the amount of available memory bandwidth and also keeps a record of how much of that bandwidth is being consumed by the several resources requiring access to main memory. When an additional system agent requires access to main memory, the agent's software device driver inquires of the resource manager to discover whether enough main memory bandwidth remains to be able to support the agent's requirements. If there is not enough bandwidth remaining, the device driver can make intelligent decisions on how best to proceed.

Although the embodiments discussed herein describe a resource manager implemented in software, other embodiments are possible using hardware implementations. Further, although the embodiments discussed below mention the management of resources included in and surrounding a graphics controller included as part of a highly-integrated multifunction chipset, other embodiments are possible that manage other types of computer system resources.

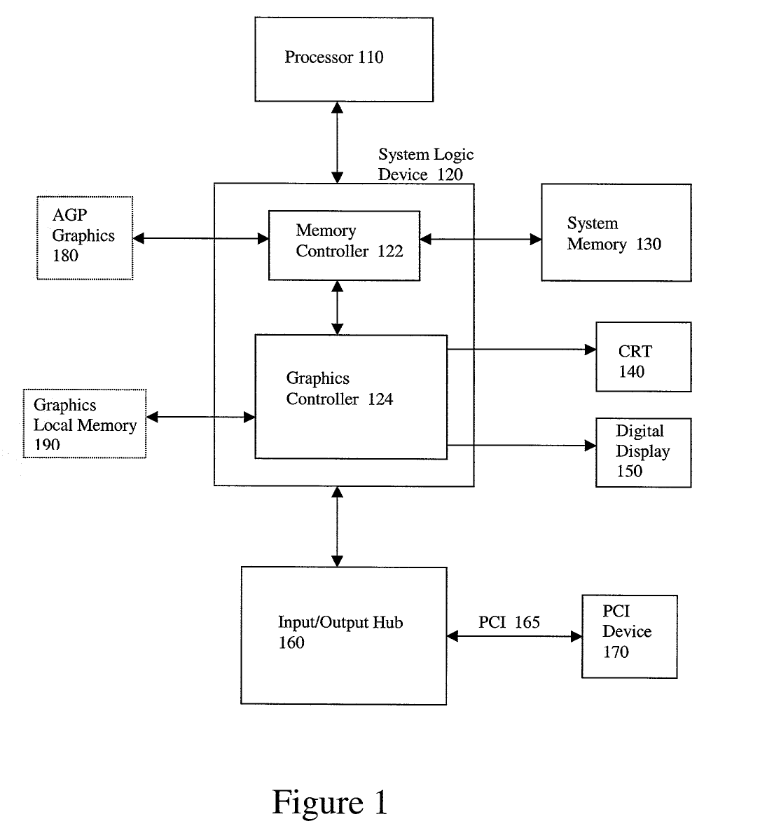

FIG. 1 is a block diagram of one embodiment of a computer system that includes a highly integrated system logic device 120. System logic devices of this type are often referred to as “chipsets.” The system logic device 120 is couple to a processor 110. The system logic device 120 includes a memory controller 122 and a graphics controller 124. The memory controller 122 is coupled to a main system memory 130. The memory controller 122 is also coupled to the graphics controller 124 and is further coupled to an optional advanced graphics port (AGP) graphics device 180. The AGP graphics device 180 can either complement or replace the graphics controller 124.

The graphics controller 124 may have many functional units including, but not limited to, rendering engines, blitter engines, video capture port units, digital display output units, digital video output units, CRT display output units, overlay units, cursor units, plane units, encoding/decoding units, etc. The graphics controller 124 may include more than one of each of these units. For purposes of example, the graphics controller 124 is shown in FIG. 1 as being coupled to a CRT display 140 and a digital display device 150.

The graphics controller 124 is also optionally coupled to a graphics local memory 190. The graphics local memory 190 is used to store graphics data. If the graphics local memory 190 is not installed, then the graphics controller will use a portion of the system memory 130 to store graphics data. Embodiments are also possible where graphics data is stored both in the graphics local memory 190 and the system memory 130.

Also coupled to the system logic device 120 is an input/output hub 160. The input/output hub 160 is further coupled via a peripheral component interconnect (PCI) bus 165 to a PCI device 170. It is possible for more than one device to be attached to the PCI bus 165. The types of devices that may be attached to the PCI bus include, but are not limited to, disk drives or other storage devices. These devices typically include data that needs to be moved to or from system memory 130.

The system of FIG. 1 includes several functional units or devices that require access to system memory 130. For example, the processor 110 requires access to system memory, as does the graphics controller 124 as well as devices coupled to the input/output hub 160. The resource manager as described herein can be used to manage the consumption of the system memory bandwidth.

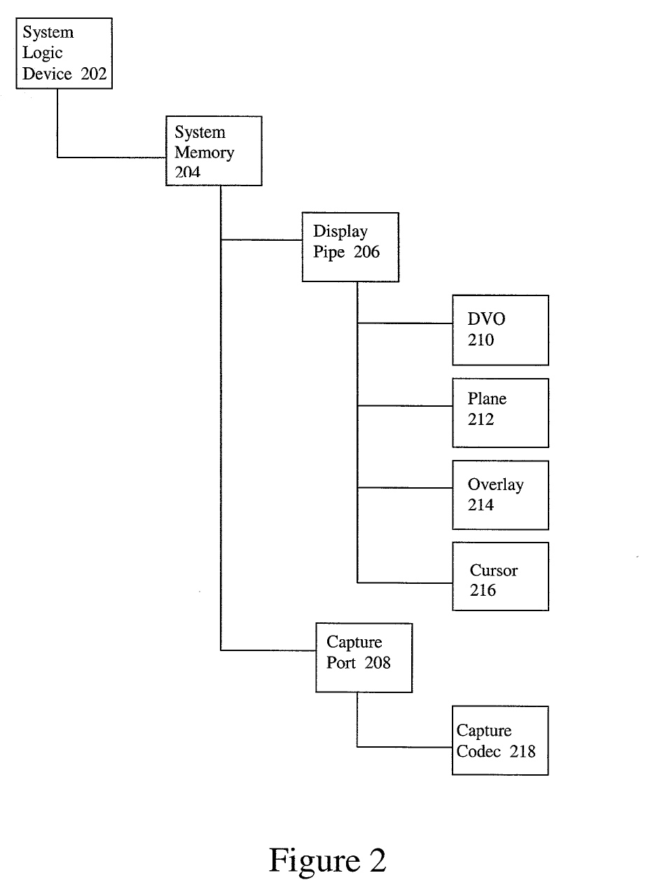

FIG. 2 is a diagram of an example global resource namespace for the system logic device 120 where the graphics controller 124 uses a portion of system memory 130 to store graphics data (the optional graphics local memory 190 is not installed). A system logic device object 202 represents the root of the namespace tree structure. A system memory object 204 is linked to the system logic device object 202. The system memory object 204 may include information to link the system memory object 204 to the system logic device object 202, as well as information uniquely identifying the system memory object 204. Information regarding system memory bandwidth may also be included as part of the system memory object 204.

Linked to the system memory object 204 are a display pipe object 206 and a capture port object 208. The display pipe object 206 represents a particular display pipe within the graphics controller 124. The graphics controller 124 may include more than one display pipe. The display pipe object 206 includes information linking the object to the system memory object 204. The display pipe object 206 also includes information that uniquely identifies the object and further may include information regarding bandwidth consumption or information regarding the rate at which pixel data is clocked through the display pipe. The display pipe object 206 may further include other information that describes various other features, capabilities, or requirements of the display pipe.

The capture port object 208 represents a video capture functional unit within the graphics controller 124. The capture port object 208 includes information linking the object to the system memory object 204. The capture port object 208 also includes information that uniquely identifies the object and further may include information regarding bandwidth consumption or information regarding the rate at which video data is transferred through the capture port. The capture port object 208 may further include other information that describes various other features, capabilities, or requirements of the capture port.

Linked to the display pipe object 206 are a digital video output (DVO) object 210, a plane object 212, an overlay object 214, and a cursor object 216. The DVO object 210 represents a digital video output unit within the graphics controller 124. The plane object 212 represents a display plane unit within the graphics controller 124. The overlay object 214 represents an overlay unit within the graphics controller 124. The cursor object 216 represents a hardware cursor unit within the graphics controller 124. The objects 210, 212, 214, and 216 include information that links the objects to the display pipe object 206. The objects 210, 212, 214, and 216 also include information regarding the bandwidth consumption properties of the respective functional units. The objects 210, 212, 214, and 216 may further include other information that describes various other features, capabilities, or requirements of the respective functional units.

Linked to the capture port object 208 is a capture coder/decoder (codec) object 218 that represents a video capture codec unit within the graphics controller 124. The capture codec object 218 includes information linking the capture codec object 218 to the capture port object 208. The capture codec object 218 also includes information regarding the bandwidth consumption properties of the video capture codec unit. The capture codec object 218 may also include information that describes other features, capabilities, or requirements of the video capture codec unit.

The resource manager can determine the net available bandwidth of the system by walking the various branches of the tree structure shown in FIG. 2 and observing the bandwidth production or consumption information included in the various objects.

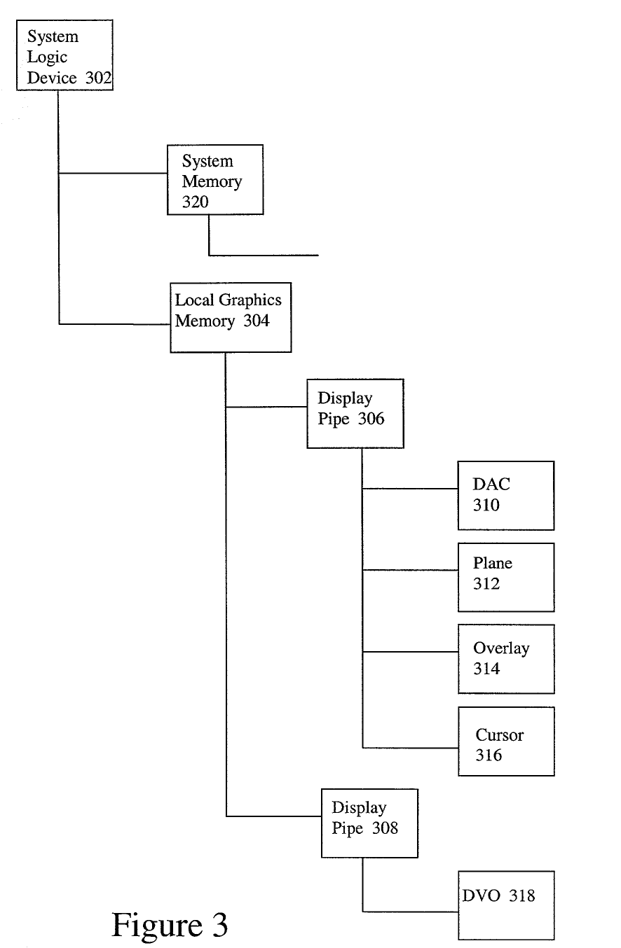

FIG. 3 is a diagram of an example namespace for the system logic device 120 including the graphics controller 124 where the graphics controller 124 uses the local graphics memory 190 to store graphics data. A system logic device object 302 represents the root of the namespace tree structure. A system memory object 320 is linked to the system logic device object 302. Although in the example embodiment of FIG. 3 no objects are shown attached to the system memory object 320, other embodiments are possible where objects representing functional units within the system logic device 120 are attached to the system memory object 320.

A local graphics memory object 304 is linked to the system logic device object 302. The local graphics memory object 304 may include information to link the local graphics memory object 304 to the system logic device object 302, as well as information uniquely identifying the local graphics memory object 304. Information regarding local graphics memory bandwidth may also be included as part of the local graphics memory object 304.

Linked to the local graphics memory object 304 are a display pipe object 306 and a display pipe object 308. The display pipe objects 306 and 308 represent two display pipes within the graphics controller 124. The display pipe objects 306 and 308 include information linking the objects to the local graphics memory object 304. The display pipe objects 306 and 308 also include information that uniquely identifies the objects and further may include information regarding bandwidth consumption or information regarding the rate at which pixel data is clocked through the display pipes. The display pipe objects 306 and 308 may further include other information that describes various other features, capabilities, or requirements of the display pipes.

Linked to the display pipe object 306 are a digital-to-analog converter (DAC) object 310, a plane object 312, an overlay object 314, and a cursor object 316. The DAC object 310 represents a digital-to-analog converter unit within the graphics controller 124. The plane object 312 represents a display plane unit within the graphics controller 124. The overlay object 314 represents an overlay unit within the graphics controller 124. The cursor object 316 represents a hardware cursor unit within the graphics controller 124. The objects 310, 312, 314, and 316 include information that links the objects to the display pipe object 306. The objects 310, 312, 314, and 316 also include information regarding the bandwidth consumption properties of the respective functional units. The objects 310, 312, 314, and 316 may further include other information that describes various other features, capabilities, or requirements of the respective functional units.

Linked to the display pipe object 308 is a DVO object 318 that represents a digital video output unit within the graphics controller 124. The DVO object 318 includes information linking the DVO object 318 to the display pipe object 308. The DVO object 318 also includes information regarding the bandwidth consumption properties of the digital video output unit. The DVO object 318 may also include information that describes other features, capabilities, or requirements of the digital video output unit.

The resource manager can determine the net available local graphics memory bandwidth by walking the various branches of the tree structure that are attached to the local graphics memory object 304 and observing the bandwidth production or consumption information included in the various objects of those branches.

Although the example namespaces of FIGS. 2 and 3 describe the namespaces as linked-lists, other embodiments may use other techniques to store and track data.

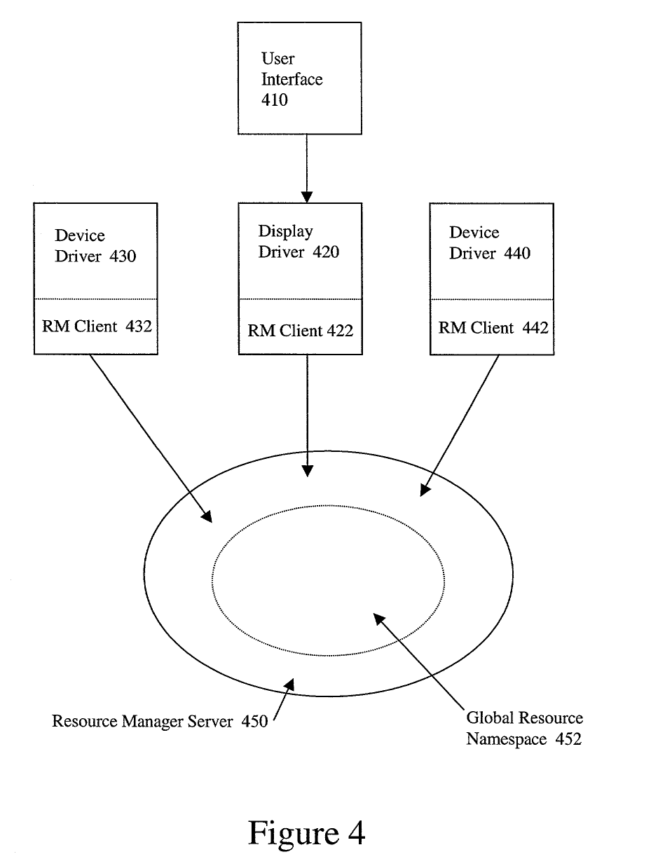

FIG. 4 is a diagram of a global resource namespace 452 within a resource manager where the resource manager is set up in a server/client arrangement including a server portion 450 and client portions 432, 422 and 442. For this example embodiment, the resource manager is implemented in software. The client portions 432, 422, and 442 of the resource manger are compiled and linked into device drivers 430, 420, and 440. A computer system may include a wide variety of software device drivers that manage the operation of a wide variety of system devices and/or functional units. For this example, device driver 420 is a display driver that manages the function of a graphics controller such as the graphics controller 124 of FIG. 1. The device drivers 430 and 440 may be device drivers for any of a wide variety of system devices or functional units.

The display driver 420 may receive input from a user interface 410. The user interface allows a computer system operator to specify display parameters such as display resolution and screen refresh rate.

As mentioned above, the resource manager can follow a client/server model. Multiple types of software drivers, and additionally multiple instances of similar drivers (e.g., one instance of a display driver per display output) can be clients. In these example embodiments, there is only a single server interface, as represented by the resource manager server 450 in FIG. 4. A variety of communication channels may be used to allow the clients (such as clients 432, 422, and 442) to access the resource manager server 450. The communication channels may include driver escapes, I/O control packets, and direct call dispatches. The clients 432, 422, and 442 communicate with a single instance of the resource manager server 450. The resource manager server 450 operates on a single global resource namespace 452. The global resource namespace 452 is initialized in this embodiment with system logic device and platform specific parameters, which may be hard-coded depending on device/revision identifiers, and clarified with information set by fuses within on-chip capability registers. Additionally, parameters typically stored in non-volatile memory such as within the system basic input/output system (BIOS) firmware may be used to further fine-tune the fundamental chip parameters with platform specifics.

The clients 432, 422, and 442 may request the resource manager server 450 to perform a number of resource management routines. Some of these routines are described as follows.

One group of routines involves querying the server interface and adding or deleting a resource reference. These routines facilitate establishing a connection between the clients 432, 422, 442, and the server 450. Upon adding a resource reference (registration), each client is tracked and it's resource allocations are tagged. Upon deleting a reference (disconnection), any resources or allocations associated with the client are purged.

Another group of routines allows real-time events within the system to be reflected in the global resource namespace. For example, system events that cause clock throttling or voltage or clock scaling may be signaled to the resource manager 450 and the resource manager 450 can make adjustments to the global resource namespace 452 to reflect the changes to affected resources.

Other software routines may allow the clients to query the resource manager server for various purposes. For example, queries may be provided to: allow a client to test if a given resource is available; allow the client to test if a given resource is attached to a given parent; check if a resource can be attached to a parent; attach a child resource to a parent using parameters provided by a client; freeing an attachment, releasing the child and its consumed resources; allow a client to pre-allocate (reserve) a child/resource, and the bandwidth necessary, as specified by given parameters, without actually completing the attachment of the resource; reverse a previous pre-allocation (reservation); and alter the parameters of an existing resource attachment, allowing it's resource consumption to be increased or decreased.

Other possible software routines allow for resource manager maintenance. One routine assesses the resource consumption of a node, parent, or branch. Another routine enumerates all of the child resources and parameters attached to the given parent or parents. This routine creates a linked-list of resources which are returned together to the calling client. An additional routine allows a client to test alternative system configurations.

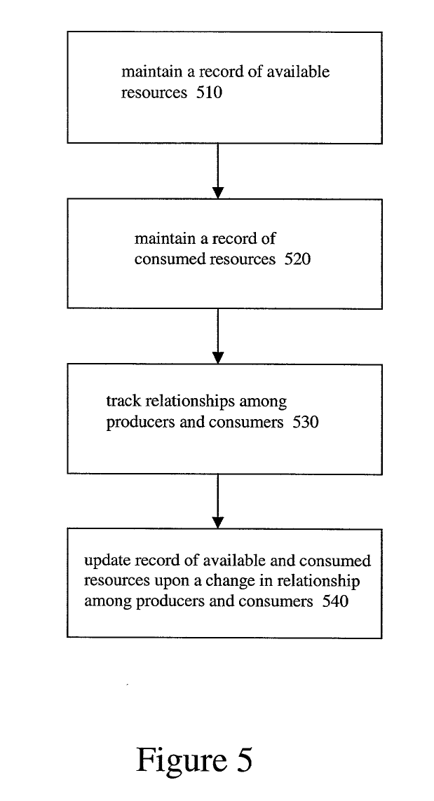

FIG. 5 is a flow diagram of one embodiment of a method for managing physical and virtual resources within a multifunction integrated chipset. At block 510, a record of available resources is maintained. A record of consumed resources is maintained at block 520. Relationships among producers and consumers are tracked at step 530. Finally, at block 540, the record of available and consumed resources is updated upon a change in relationship among producers and consumers.

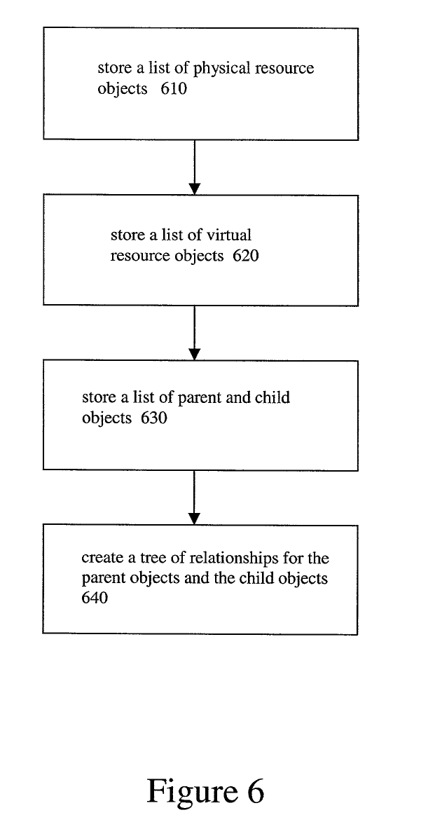

FIG. 6 is a flow diagram of an additional embodiment of a method for managing physical and virtual resources within a multifunction integrated chipset. At block 610, a list of physical resource objects is stored. A list of virtual resource objects is stored at block 620. A list of parent and child objects is stored at block 630. Finally, at block 640, a tree of relationships for the parent objects and the child objects is created.

In the foregoing specification the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than in a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

What is claimed is:

1. A method, comprising:
storing a list of physical resource objects;
storing a list of virtual resource objects;
storing a list of parent and child objects; and
creating a tree of relationships for the parent and child objects and the physical and virtual resources.

2. The method of claim 1, wherein storing a list of virtual resource objects includes storing an object representing system memory bandwidth.

3. The method of claim 2, wherein storing a list of child objects includes storing an object representing a functional unit that consumes bandwidth.

4. The method of claim 3, wherein storing an object representing a functional unit that consumes bandwidth includes storing an indication of the amount of bandwidth consumed.

5. The method of claim 4, wherein storing an object representing a functional unit that consumes bandwidth includes storing an object that represents an overlay unit.

6. The method of claim 4, wherein storing an object representing a functional unit that consumes bandwidth includes storing an object that represents a cursor unit.

7. The method of claim 4, wherein storing an object representing a functional unit that consumes bandwidth includes storing an object that represents a display output unit.

8. The method of claim 1, wherein storing a list of virtual resource objects includes storing an object representing local graphics memory bandwidth.

9. The method of claim 8, wherein storing a list of child objects includes storing an object representing a functional unit that consumes bandwidth.

10. The method of claim 9, wherein storing an object representing a functional unit that consumes bandwidth includes storing an indication of the amount of bandwidth consumed.

11. The method of claim 10, wherein storing an object representing a functional unit that consumes bandwidth includes storing an object that represents an overlay unit.

12. The method of claim 10, wherein storing an object representing a functional unit that consumes bandwidth includes storing an object that represents a cursor unit.

13. The method of claim 10, wherein storing an object representing a functional unit that consumes bandwidth includes storing an object that represents a display output unit.

14. A method, comprising:
maintaining a record of available resources;
maintaining a record of consumed resources;
tracking relationships among producers and consumers; and
updating record of available and consumed resources upon a change in relationship among producers and consumers.

15. The method of claim 14, wherein tracking relationships among producers and consumers includes tracking a relationship between a system memory bandwidth producer and a system memory bandwidth consumer.

16. The method of claim 14, wherein tracking relationships among producers and consumers includes tracking a relationship between a graphics local memory bandwidth producer and a graphics local memory consumer.

17. A machine-readable medium having stored thereon instructions which, when executed by a computer system, causes the computer system to perform a method comprising:
storing a list of physical resource objects;
storing a list of virtual resource objects;
storing a list of parent and child objects; and
creating a tree of relationships for the parent and child objects and the physical and virtual resources.

18. The machine-readable medium of claim 17, wherein storing a list of virtual resource objects includes storing an object representing system memory bandwidth.

19. The machine-readable medium of claim 18, wherein storing a list of child objects includes storing an object representing a functional unit that consumes bandwidth.

20. The machine-readable medium of claim 19, wherein storing an object representing a functional unit that consumes bandwidth includes storing an indication of the amount of bandwidth consumed.

21. The machine-readable medium of claim 20, wherein storing an object representing a functional unit that consumes bandwidth includes storing an object that represents an overlay unit.

22. The machine-readable medium of claim 20, wherein storing an object representing a functional unit that consumes bandwidth includes storing an object that represents a cursor unit.

23. The machine-readable medium of claim 20, wherein storing an object representing a functional unit that consumes bandwidth includes storing an object that represents a display output unit.

24. The machine-readable medium of claim 17, wherein storing a list of virtual resource objects includes storing an object representing local graphics memory bandwidth.

25. The machine-readable medium of claim 24, wherein storing a list of child objects includes storing an object representing a functional unit that consumes bandwidth.

26. The machine-readable medium of claim 25, wherein storing an object representing a functional unit that consumes bandwidth includes storing an indication of the amount of bandwidth consumed.

27. The machine-readable medium of claim 26, wherein storing an object representing a functional unit that consumes bandwidth includes storing an object that represents an overlay unit.

28. The machine-readable medium of claim 26, wherein storing an object representing a functional unit that consumes bandwidth includes storing an object that represents a cursor unit.

29. The machine-readable medium of claim 26, wherein storing an object representing a functional unit that consumes bandwidth includes storing an object that represents a display output unit.

30. A machine-readable medium having stored thereon instructions which, when executed by a computer system, causes the computer system to perform a method comprising:
maintaining a record of available resources;
maintaining a record of consumed resources;
tracking relationships among producers and consumers; and
updating record of available and consumed resources upon a change in relationship among producers and consumers.

31. The machine-readable medium of claim 30, wherein tracking relationships among producers and consumers includes tracking a relationship between a system memory bandwidth producer and a system memory bandwidth consumer.

32. The machine-readable medium of claim 31, wherein tracking relationships among producers and consumers includes tracking a relationship between a graphics local memory bandwidth producer and a graphics local memory consumer.
